(19) United States
(12) Patent Application Publication
(10) Pub. No.: US 2015/0039517 A1
(43) Pub. Date: Feb. 5, 2015

(54) CLOUD ENTERTAINMENT PLATFORM

(71) Applicant: MOZIDO, INC., Austin, TX (US)

(72) Inventors: Michael A. Liberty, Windermere, FL (US); Steve Bacastow, Cumming, GA (US); Mike Love, Austin, TX (US)

(21) Appl. No.: 14/341,605

(22) Filed: Jul. 25, 2014

Related U.S. Application Data
(60) Provisional application No. 61/862,437, filed on Aug. 5, 2013.

(51) Int. Cl. G06Q 20/36; G06Q 20/40; G06Q 20/12

(52) U.S. Cl. CPC G06Q 20/3674; G06Q 20/123; G06Q 20/401; G06Q 2220/00
USPC 705/67

(57) ABSTRACT

Embodiments are directed to purchasing content provided by a cloud-based entertainment platform and to accessing media content provided by a cloud-based entertainment platform. In one scenario, a computer system receives authentication credentials from a user. The computer system authenticates the user to the cloud-based entertainment platform using the received authentication credentials. The computer system then receives payment data from the authenticated user, where the payment data includes a tokenized QR code that contains an indication of the media items being purchased and embedded account information for both the provider of the selected media items and the user. The computer system also processes a payment transaction based on the indication of media items being purchased and the embedded account information in the tokenized QR code and, upon determining that the authenticated user has paid for a media item, transmits the purchased media item to the user.

### CROSS-REFERENCE TO RELATED APPLICATIONS

This application claims priority to and the benefit of U.S. Provisional Patent Application No. 61/862,437, entitled “Cloud Entertainment Platform”, filed on Aug. 5, 2013, which application is incorporated by reference herein in its entirety.

### BACKGROUND

Over the past several decades, significant shifts have arisen in the way that entertainment content is distributed to consumers. These shifts have largely been driven by technological innovations, and have resulted in the creation of new business models around entertainment content distribution. For example, VCR tapes and DVDs enabled “mom and pop” video stores to emerge and flourish, only later to be trumped by larger players such as BlockBuster®. The Internet enabled online media providers such as Amazon® to replace brick and mortar stores for the distribution of DVDs and music CDs. Broadband internet, enabled streaming video content, satellite technology enabled streaming radio content, and mobile devices such as MP3 players, tablets, and smart phones capable of downloading, storing and playing entertainment content drove the creation of digital content marketplaces such as iTunes and Google Play. These marketplaces have become the dominant global entertainment content distributors and gatekeepers.

Through each of the aforementioned technically-driven examples of changes in entertainment content distribution, consumers with ‘economic means’ have largely benefited from the increased availability of entertainment content and a growing choice of presentation venues which leverage the capabilities of smart phones, mobile devices and available data plans. However, many consumers with fewer economic means have not enjoyed such widespread access to digital media.

### BRIEF SUMMARY

Embodiments described herein are directed to purchasing content provided by a cloud-based entertainment platform and to accessing media content provided by a cloud-based entertainment platform. In one embodiment, a computer system receives authentication credentials from a user. The computer system authenticates the user to the cloud-based entertainment platform using the received authentication credentials. The computer system then receives payment data from the authenticated user, where the payment data includes a tokenized QR code that contains an indication of the media items being purchased and embedded account information for both the provider of the selected media items and the user. The computer system also processes a payment transaction based on the indication of media items being purchased and the embedded account information in the tokenized QR code and, upon determining that the authenticated user has paid for a media item, transmits the purchased media item to the user.

In another embodiment, a computer system accesses media content provided by a cloud-based entertainment platform. The computer system receives an indication of media items provided by the cloud-based entertainment platform and selects media items that are to be purchased using a tokenized quick response (QR) code. The computer system sends user credentials to the cloud-based entertainment platform to authenticate the user and receives an indication that the user has been authenticated to the cloud-based entertainment platform. The computer system generates a tokenized QR code including an indication of the media items being purchased and embedded account information for both the provider of the selected media items and the user and sends the generated tokenized QR code to the cloud-based entertainment platform for processing of the payment transaction using the embedded account information. The computer system further receives an electronic receipt of the financial transaction indicating the status of the transaction.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Additional features and advantages will be set forth in the description which follows, and in part will be apparent to one of ordinary skill in the art from the description, or may be learned by the practice of the teachings herein. Features and advantages of embodiments described herein may be realized and obtained by means of the instruments and combinations particularly pointed out in the appended claims. Features of the embodiments described herein will become more fully apparent from the following description and appended claims.

### BRIEF DESCRIPTION OF THE DRAWINGS

To further clarify the above and other features of the embodiments described herein, a more particular description will be rendered by reference to the appended drawings. It is appreciated that these drawings depict only examples of the embodiments described herein and are therefore not to be considered limiting of its scope. The embodiments will be described and explained with additional specificity and detail through the use of the accompanying drawings in which:

FIG. 1 illustrates an example system architecture for a mobile wallet platform.

FIG. 2 illustrates a computer architecture in which embodiments described herein may operate including purchasing content provided by a cloud-based entertainment platform.

FIG. 3 illustrates a computer architecture in which embodiments described herein may operate including accessing media content provided by a cloud-based entertainment platform.

FIG. 4 illustrates an embodiment in which a first user transfers a media item to a second user and upon purchase of the media item by the second user, the first user receives a commission.

FIG. 5 illustrates a flowchart of an example method for purchasing content provided by a cloud-based entertainment platform.

FIG. 6 illustrates a flowchart of an example method for accessing media content provided by a cloud-based entertainment platform.

### DETAILED DESCRIPTION

Embodiments described herein are directed to purchasing content provided by a cloud-based entertainment platform and to accessing media content provided by a cloud-based entertainment platform. In one embodiment, a computer system receives authentication credentials from a user. The computer system authenticates the user to the cloud-based entertainment platform using the received authentication credentials. The computer system then receives payment data from the authenticated user, where the payment data includes a tokenized QR code that contains an indication of the media items being purchased and embedded account information for both the provider of the selected media items and the user. The computer system also processes a payment transaction based on the indication of media items being purchased and the embedded account information in the tokenized QR code and, upon determining that the authenticated user has paid for a media item, transmits the purchased media item to the user.

In another embodiment, a computer system accesses media content provided by a cloud-based entertainment platform. The computer system receives an indication of media items provided by the cloud-based entertainment platform and selects media items that are to be purchased using a tokenized quick response (QR) code. The computer system sends user credentials to the cloud-based entertainment platform to authenticate the user and receives an indication that the user has been authenticated to the cloud-based entertainment platform. The computer system generates a tokenized QR code including an indication of the media items being purchased and embedded account information for both the provider of the selected media items and the user and sends the generated tokenized QR code to the cloud-based entertainment platform for processing of the payment transaction using the embedded account information. The computer system further receives an electronic receipt of the financial transaction indicating the status of the transaction.

The following discussion now refers to a number of methods and method acts that may be performed. It should be noted, that although the method acts may be discussed in a certain order or illustrated in a flow chart as occurring in a particular order, no particular ordering is necessarily required unless specifically stated, or required because an act is dependent on another act being completed prior to the act being performed.

Embodiments described herein may comprise or utilize a special purpose or general-purpose computer including computer hardware, such as, for example, one or more processors and system memory, as discussed in greater detail below. Embodiments described herein also include physical and other computer-readable media for carrying or storing computer-executable instructions and/or data structures. Such computer-readable media can be any available media that can be accessed by a general purpose or special purpose computer system. Computer-readable media that store computer-executable instructions in the form of data are computer storage media. Computer-readable media that carry computer-executable instructions are transmission media. Thus, by way of example, and not limitation, embodiments described herein can comprise at least two distinctly different kinds of computer-readable media: computer storage media and transmission media.

Computer storage media includes RAM, ROM, EEPROM, CD-ROM, solid state drives (SSDs) that are based on RAM, Flash memory, phase-change memory (PCM), or other types of memory, or other optical disk storage, magnetic disk storage or other magnetic storage devices, or any other medium which can be used to store desired program code means in the form of computer-executable instructions, data or data structures and which can be accessed by a general purpose or special purpose computer.

A “network” is defined as one or more data links and/or data switches that enable the transport of electronic data between computer systems and/or modules and/or other electronic devices. When information is transferred or provided over a network (either hardwired, wireless, or a combination of hardwired or wireless) to a computer, the computer properly views the connection as a transmission medium. Transmission media can include a network which can be used to carry data or desired program code means in the form of computer-executable instructions or in the form of data structures and which can be accessed by a general purpose or special purpose computer. Combinations of the above should also be included within the scope of computer-readable media.

Further, upon reaching various computer system components, program code means in the form of computer-executable instructions or data structures can be transferred automatically from transmission media to computer storage media (or vice versa). For example, computer-executable instructions or data structures received over a network or data link can be buffered in RAM within a network interface module (e.g., a network interface card or “NIC”), and then eventually transferred to computer system RAM and/or to less volatile computer storage media at a computer system. Thus, it should be understood that computer storage media can be included in computer system components that also (or even primarily) utilize transmission media.

Computer-executable (or computer-interpretable) instructions comprise, for example, instructions which cause a general purpose computer, special purpose computer, or special purpose processing device to perform a certain function or group of functions. The computer executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that various embodiments may be practiced in network computing environments with many types of computer system configurations, including personal computers, desktop computers, laptop computers, message processors, hand-held devices, multi-processor systems, microprocessor-based or programmable consumer electronics, network PCs, minicomputers, mainframe computers, mobile telephones, PDAs, tablets, pagers, routers, switches, and the like. Embodiments described herein may also be practiced in distributed system environments where local and remote computer systems that are linked (either by hardwired data links, wireless data links, or by a combination of hardwired and wireless data links) through a network, each perform tasks (e.g. cloud computing, cloud services and the like). In a distributed system environment, program modules may be located in both local and remote memory storage devices.

In this description and the following claims, “cloud computing” is defined as a model for enabling on-demand network access to a shared pool of configurable computing resources (e.g., networks, servers, storage, applications, and services). The definition of “cloud computing” is not limited to any of the other numerous advantages that can be obtained from such a model when properly deployed.

For instance, cloud computing is currently employed in the marketplace so as to offer ubiquitous and convenient on-demand access to the shared pool of configurable computing resources. Furthermore, the shared pool of configurable computing resources can be rapidly provisioned via virtualization and released with low management effort or service provider interaction, and then scaled accordingly.

A cloud computing model can be composed of various characteristics such as on-demand self-service, broad network access, resource pooling, rapid elasticity, measured service, and so forth. A cloud computing model may also come in the form of various service models such as, for example, Software as a Service (“SaaS”), Platform as a Service (“PaaS”), and Infrastructure as a Service (“IaaS”). The cloud computing model may also be deployed using different deployment models such as private cloud, community cloud, public cloud, hybrid cloud, and so forth. In this description and in the claims, a “cloud computing environment” is an environment in which cloud computing is employed.

Additionally or alternatively, the functionally described herein can be performed, at least in part, by one or more hardware logic components. For example, and without limitation, illustrative types of hardware logic components that can be used include Field-programmable Gate Arrays (FPGAs), Program-specific Integrated Circuits (ASICs), Program-specific Standard Products (ASSPs), System-on-a-chip systems (SOCs), Complex Programmable Logic Devices (CPLDs), and other types of programmable hardware.

Still further, system architectures described herein can include a plurality of independent components that each contribute to the functionality of the system as a whole. This modularity allows for increased flexibility when approaching issues of platform scalability and, to this end, provides a variety of advantages. System complexity and growth can be managed more easily through the use of smaller-scale parts with limited functional scope. Platform fault tolerance is enhanced through the use of these loosely coupled modules. Individual components can be grown incrementally as business needs dictate. Modular development also translates to decreased time to market for new functionality. New functionality can be added or subtracted without impacting the core system.

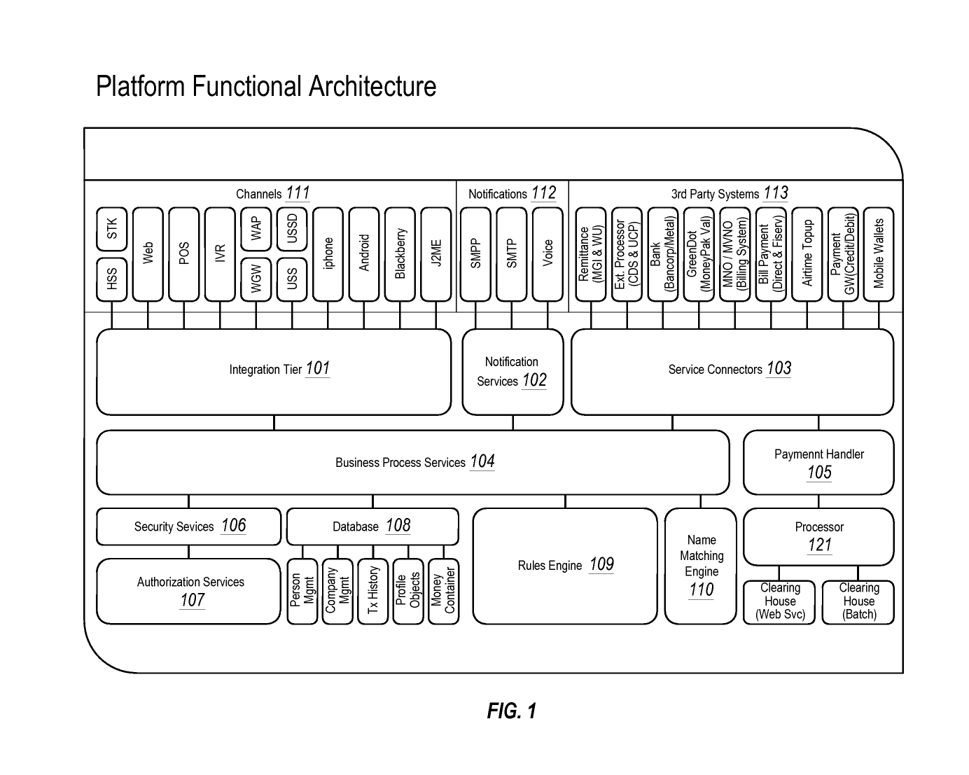

FIG. 1 illustrates an example system architecture for a mobile wallet platform. Integration tier 101 is configured to manage mobile wallet sessions and maintain integrity of financial transactions. Integration tier 101 can also include a communication (e.g., Web services) API and/or other communication mechanisms to accept messages from channels 111. Other mechanisms include, but are not limited to: International Standards Organization (“ISO”) 8583 for Point of Sale (“POS”) and Automated Teller Machines (“ATM”) devices and Advanced Message Queuing Protocol (“AMQP”) for queue based interfaces. Each of channels 111 can be integrated to one or more mechanisms for sending messages to integration tier 101. Notification services 102 is configured to send various notifications through different notification channels 112, such as, for example, Short Message Peer-to-Peer (“SSMP”) for Short Messaging Service (“SMS”) and Simple Mail Transfer Protocol (“SMTP”) for emails. Notification services 102 can be configured through a web services API.

Service connectors 103 are a set of connectors configure to connect to 3rd party systems 113. Each connector can be a separate module intended to integrate an external service to the system architecture. Business process services 104 are configured to implement business workflows, including executing financial transactions, auditing financial transactions, invoking third-party services, handling errors, and logging platform objects. Payment handler 105 is configured to wrap APIs of different payment processors, such as, for example, banking accounts, credit/debit cards or processor 121. Payment handler 105 exposes a common API to facilitate interactions with many different kinds of payment processors.

Security services 106 are configured to perform subscriber authentication. Authorization services 107 are configured to perform client authorization, such as, for example, using a database-based Access Control List (“ACL”) table.

Database 108 is configured to manage customer accounts (e.g., storing customer accounts and properties), manage company accounts (e.g., storing company accounts and properties), manage transaction histories (e.g., storing financial transaction details), store customer profiles, storing dictionaries used by the mobile wallet platform, such as, for example, countries, currencies, etc., and managing money containers. Rules engine 109 is configured to gather financial transaction statistics and uses the statistics to provide transaction properties, such as, for example, fees and bonuses. Rules engine 109 is also configured to enforce business constraints, such as, for example, transactions and platform license constraints.

Name matching engine 110 is configured to match different objects according to specified configuration rules. Matching engine 110 can be used to find similarities between names, addresses, etc. Transaction processor 121 is configured to manage financial accounts and transactions. The transaction processor 121 can be used to hold, load, withdraw and deposit funds to mobile wallet accounts. Transaction processor 121 can also be used as a common interface to a third party processor system. When used as a common interface, financial operations may be delegated to the external processor. A Clearing House subsystem of transaction processor 121 can be used to exchange the financial information with a bank.

Components of a mobile wallet platform can be connected to one another over (or be part of) a system bus and/or a network. Networks can include a Local Area Network (“LAN”), a Wide Area Network (“WAN”), and even the Internet. Accordingly, components of the mobile wallet platform can be “in the cloud”. As such, mobile wallet platform components as well as any other connected computer systems and their components, can create message related data and exchange message related data (e.g., Internet Protocol (“IP”) datagrams and other higher layer protocols that utilize IP datagrams, such as, Transmission Control Protocol (“TCP”), Hypertext Transfer Protocol (“HTTP”), Simple Mail Transfer Protocol (“SMTP”), etc.) over the system bus and/or network.

The components depicted in FIG. 1 can interoperate to provide a number of financial and other services including but not limited to enrolling a customer for a mobile wallet, adding a stored value account (either hosted by a mobile wallet platform or a third party), adding a bank or credit union account to a mobile wallet, adding a debit or credit card account to a mobile wallet, depositing funds in a mobile wallet, withdrawing funds from a mobile wallet, paying bills from a mobile wallet, topping up a prepaid mobile account through a mobile wallet, transferring funds through a mobile wallet (nationally or internationally), making in-store purchases using a mobile wallet, and various other tasks as described herein below.

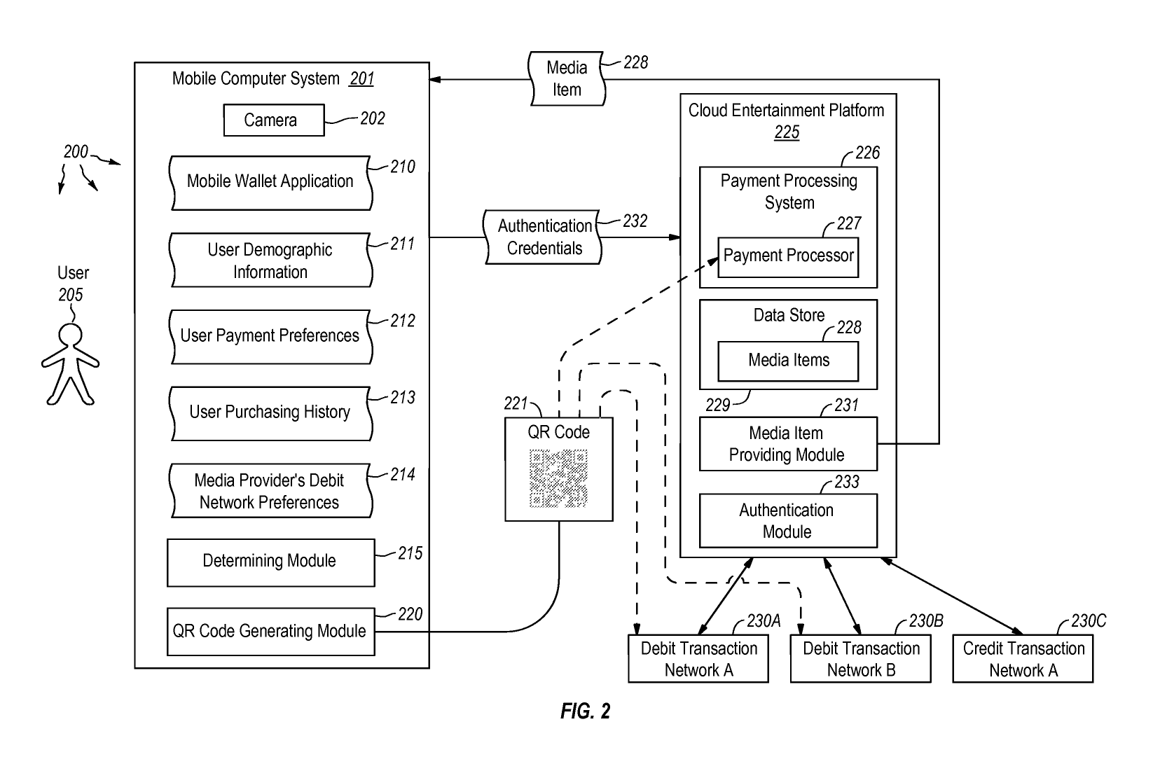

The telephone, smartphone, tablet or other computing system that interacts with the mobile payment system typically includes a camera, image sensor, image scanner or other hardware that allows a user to scan or capture an image. For instance, as shown in environment 200 of FIG. 2, mobile computer system 201 may include a camera 202. The mobile computer system 201 may include a telephone, smartphone, tablet or other type of mobile computing system. The user of the phone 201 (i.e. user/customer 205) may thus point the camera 202 or other hardware at an object such as a can of soup and either take a picture of the object, or allow software to scan the image using the camera. Software on the phone or tablet 201 then performs a local search or consults a database (e.g. over the internet) to retrieve information related to that item or product including coupons or price discounts.

In addition to receiving product information and discounts, the user 205 may also use their phone 201 or other device to pay for the media items they wish to buy. In one embodiment, a customer may use their mobile phone 201 to access a cloud-based entertainment platform 225. The cloud-based entertainment platform 225, as generally referred to herein, includes a cloud-based service, application, portal, infrastructure or other functionality that allows users to log in and purchase media items 228. These media items may then be downloaded to the user's mobile phone 201, or may be streamed on demand. The media items 228 may include any type of media item including music, movies, applications, ringtones, video games or other items. The media items may be provided directly by the producers. Thus, music producers may sell music tracks or albums directly to customers using the cloud-based entertainment platform 225. Similarly, movie producers, video game makers, application developers or other media producers may also provide their goods directly to consumers via the cloud-based entertainment platform 225.

A user may browse or search through the available media items 228 using their mobile phone 201 (either via a web browser or an entertainment-platform-specific application. The user 205 may select various items they wish to purchase (or rent, where applicable). Once the customer 205 has finished shopping, he or she may pay for the selected media items using a mobile wallet 210. The mobile wallet application may run on the mobile computer system 201, whether it is a smart phone, a feature phone (i.e. a phone that provides may features beyond just phone calls, but lacks at least some of the more advanced features provided by a smartphone), a tablet or other type of mobile computer system. The mobile wallet application 210 may allow the user to pay for the item using a credit, debit or other account established through the mobile wallet. In some cases, the user may be an “unbanked” user, meaning that the user does not have a traditional bank account. In such cases, the mobile wallet application may link to a credit card, a stored value card or other type of non-bank account that stores value.

Thus, when paying for the media items 228, the determining module 215 of user's digital device 201 may determine that the user 205 is attempting to use their mobile wallet application 210 to pay for the items. The mobile wallet application 210 may use various types of information to determine which debit or credit network is to be used to process the payment transaction (e.g. debit networks 230A or 230B, or credit network 230C). As will be understood by one skilled in the art, various different debit and credit networks exist for processing debit transactions (e.g. Star, Nice, Visa, MasterCard, etc.). These networks conduct the transactions between the media item producer's bank and the customer's bank (or credit card issuer) that allow the user to pay for items using a debit or credit card linked to their own checking or credit account.

In some cases, the decision as to which payment network to use for a given transaction will be based on either the customer's demographic information, the customer's payment preferences or the customer's purchasing history. For example, the user 205 may provide demographic information 211 to the mobile wallet application 210 indicating age or age range, income or income range, general housing location and other similar information. This information may be used, at least in some cases, to provide targeted advertisements, promotions or coupons to the user via the mobile wallet. The user's demographic information 211 may provide indications or other clues that the user may prefer one payment network over another (e.g. for cost reasons, or convenience reasons). Accordingly, this information may be used by determining module 215 when determining which debit network to use for a given transaction.

Similarly, user payment preferences 212 and/or user purchasing history 213 for user 205 may be used to determine which payment network to use for a payment transaction. For example, if the user has indicated in their payment preferences which debit or credit network to use, that information may be provided to the determining module 215. In some cases, the user's phone may have a button that allows the user to select the method of payment and/or the specific debit or credit network that is to be used to process the transaction. Moreover, if the user's purchasing history indicates that a specified debit network has been used in all or most of the user's debit transactions, that information could also be used by the determining module 215 when making its decision as to which debit network to use. The decision as to which payment network to use may be based on any one of the user's demographic information 211, the user's payment preferences 212 or the user's purchasing history 213, or a combination thereof.

Still further, other factors may be taken into account when determining which payment network to use. For instance, the decision may also be based on the media provider's preferences. For example, different media providers may prefer to use certain payment networks due to various factors including pricing. Thus, retail location 225 may prefer to use debit network 230A over debit network 230B because debit network 230A charges less per debit transaction. Or, the retail location may specify that they prefer to use different debit networks at different times of the day, or may specify that they prefer to use different debit networks at their East Coast and West Coast branches. Accordingly, a media provider may specify preferences that vary based on different factors. In some embodiments, these preferences may be broadcast to users' mobile wallet applications while they are shopping at the store.

Thus, in this manner, based on customer information (e.g. 211-213) and/or the media provider's preferences 214, the user's mobile wallet application 210 may determine which payment network is to be used to route the user's transaction. Once it has been determined which payment network is going to be used, a QR code 221 may be generated by module 220 with the payment network selection embedded therein. This QR code 221 may then be presented to the entertainment platform 225 when making the purchase. The QR code has each of the necessary transaction details embedded therein, and may also indicate on which payment network the transaction is to take place. In some cases, the QR code may link directly to the selected payment network (as indicated by the dotted arrow lines to debit networks 230A and 230B, and to credit network 230C). In such cases, the user may route their payment for media items 228 directly to the debit or credit network using their mobile wallet, thus bypassing the Payment Processor 227.

The QR code 221 is a secure, tokenized QR code that fully represents the details of the user's purchase, along with an indication of which payment network has been specified for that transaction. This QR code is scannable or electronically readable by the entertainment platform 225. Once the QR code has been scanned or read, the credit or debit network selection through which the transaction is to be processed is provided.

In some cases, the payment network selection may be determined dynamically for each customer. Thus, each customer may use a different payment network to process their transactions. Moreover, the payment network selection may be determined dynamically for each media provider. Thus, as with customers, each media provider may specify a certain debit or credit network that is to be used when such transactions take place. In some cases, the media provider's preference for certain debit or credit networks may take precedence over the user's preferences or buying history.

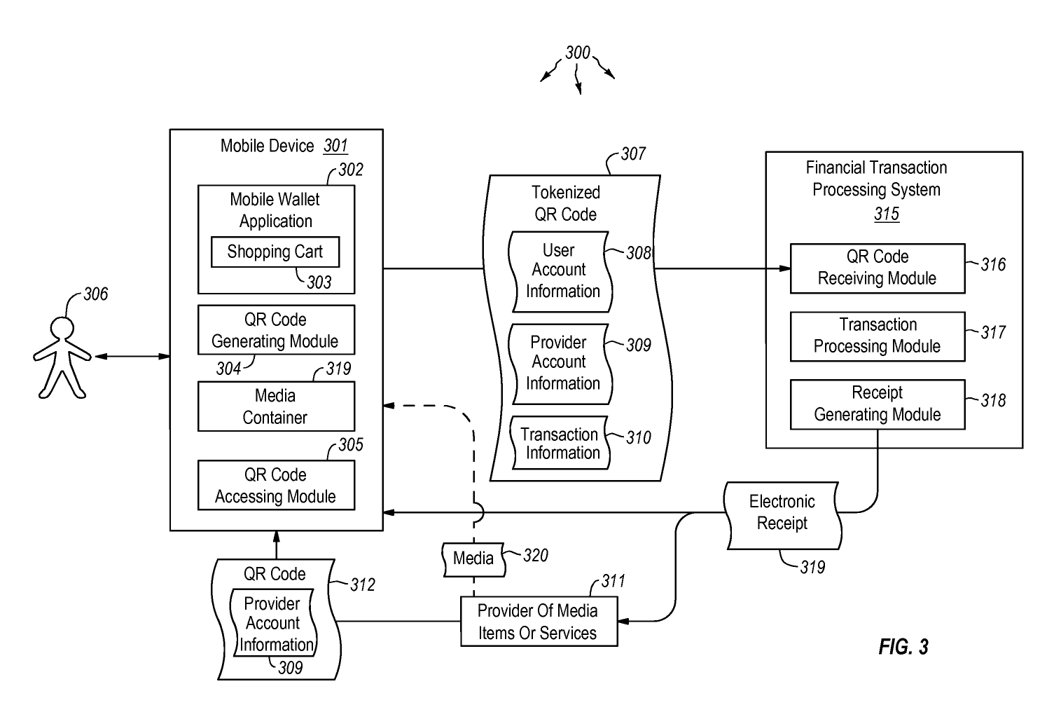

The cloud-based entertainment platform 225 includes a payment processing system 226 that includes at least one payment processor 227. The payment processing system (and/or the entertainment platform itself) may incorporate both private and public clouds. The clouds may include substantially any number of processing units. These processing units may include CPU's and system memory. The processing units may be configured to run software or virtual machines that, themselves, run software. The software may be configured to process transactions between media providers and customers. For example, as shown in FIG. 3, the financial transaction processing system 315 may process a transaction between a media provider 311 and customer 306. As mentioned above, the media provider may be the actual producer of the media items, or may be a middle-man between the producer and the customer. The media provider may offer media items or services for sale. The customer 305 may desire to purchase one or more of these media items or services. This transaction will now be described from the reference point of the financial transaction processing system 315.

The computing architecture 300 of FIG. 3 allows a user 306 to directly purchase media items from a media provider 311 using a quick response (QR) code 307. These items may be any type of media items including music tracks or albums, movies, games, apps or other media items. The provider of the goods or services 311 may be any type of media producer or seller. For example, the provider 311 may be an individual music artist selling their music tracks on the entertainment platform 225. Any media provider may allow their goods or services to be purchased (or rented) using a QR code 312 (or 221 from FIG. 2).

The QR code 312 may be a tokenized QR code that is encrypted with various portions of information. For example, the QR code 312 provided by the media provider in conjunction with a particular media item may include the price of the media item, and may also include the provider's account information 309 in an encrypted form. The account information may link to debit, credit or other accounts that the media provider may use to receive payment for the media item. The QR code 312 may be provided to the user (i.e. to the user's mobile device 301) in a variety of different manners. For instance, the QR code 312 may be printed alongside an advertisement associated with the media item. Additionally or alternatively, the QR code 312 may be displayed on a website or in an application in conjunction with the media item, or may be sent electronically, directly to the mobile device 301. Regardless of where the QR code 312 is displayed, or how the QR code is received, the code may be accessed by the QR code accessing module 305.

The QR code accessing module 305 may read and interpret the provider's QR code 312 to extract the pricing, media item or other information. In most embodiments, the provider's account information 309 will remain in encrypted form. The media item may be placed in the user's shopping cart 303 within their mobile wallet application 302, or may be purchased directly without being placed in a shopping cart. When the user 306 desires to pay for the media item, the QR code generating module 304 on the mobile device 301 may generate a new tokenized QR code 307 that includes not only the media provider's encrypted account information 309 and the transaction information 310 (selected media item, price, location, time, availability and/or application of loyalty points, rewards, coupons, etc.), but also the user's encrypted account information 308. This QR code 307 is then sent to the QR code receiving module 316 of the financial transaction processing system 315.

The financial transaction processing system 315 may be any type of local or distributed (i.e. cloud) computing system. The financial transaction processing system 315 may be communicatively connected to debit networks, credit networks, banks or other financial institutions or systems. The transaction processing module 317 of the financial transaction processing system 315 may process the transaction identified by the QR code 307 using the user's account information 308, the media provider's account information 309 and the corresponding transaction information 310. Once the transaction has been processed using the appropriate payment network(s), the receipt generating module 318 of the financial transaction processing system 315 generates an electronic receipt 319 that is sent to the user 306 (i.e. to the user's mobile device 301) and the media item provider 311. Once the receipt of payment has been received, the provider can transfer the media item 320 to the user's mobile phone over a cellular, WiFi or other wireless connection. The purchased media item may be securely stored in a media container 319 stored within the mobile device. The media item may include a digital watermark to identify it as being genuine and/or originating from the media producer. In this manner, a user can directly purchase media items using a QR code.

In one embodiment, as seen from the financial transaction processing system's point of view, the financial transaction processing system 315 may receive from user 306 a tokenized QR code 307 indicating that the user has initiated a financial transaction using a mobile wallet application 302 to pay for one or more items sold by a provider 311. The tokenized QR code 307 includes embedded account information for both the media provider (i.e. account information 309) and the user (i.e. account information 308). The financial transaction processing system 315 may determine from the tokenized QR code the amount of money that is to be transferred from the user 306 to the provider 311 as part of the financial transaction.

The financial transaction processing system 315 may also determine which of the user's stored value accounts is to be used to pay for the one or more media items provided by the provider 311. The stored value accounts may include checking or savings accounts, credit accounts, prepaid debit accounts or other stored value accounts. The financial transaction processing system 315 may then transfer the determined amount of money from the determined stored value account to the provider's account (as indicated by the encrypted account information 309 embedded in QR code 307) and send an electronic receipt 319 of the financial transaction to the user 306 and the provider 311.

In some embodiments, loyalty points or rewards may be factored into the transaction. The financial transaction processing system 315 may determine that various discounts or loyalty points are to be applied to the financial transaction to reduce the amount of the financial transaction by a specified amount (or even make the item free). The financial transaction processing system 315 may then apply the discounts or loyalty points to the transaction to reduce the amount of the transaction by the specified amount. This determination may include accessing the user's purchasing history with that media provider. If the user has a long purchasing history with that media provider, the media provider may choose to apply discounts or loyalty points to reduce the price of the media items being purchased. In some cases, the media provider may specify which payment network (e.g. debit or credit network) is to be used to route the transactions through.

In another embodiment, described now from user 306's perspective, the QR code accessing module 305 of the user's mobile device 301 may receive from a media provider 311 a tokenized QR code 312 corresponding to the media provider. The tokenized QR code includes embedded account information for the media provider for use in processing financial transactions with the media provider (e.g. bank or credit account, transaction-specific information, etc.). The QR code accessing module 305 may determine from the QR code 312, or the user may separately receive an indication of which items provided by the media provider are to be added to a shopping cart 303 running in a mobile wallet application 302. These items may be selected by the user by scanning the QR code provided by the media provider (i.e. QR code 312).

The mobile wallet application 302 may determine the sum total of the price of each selected item, and the QR code generating module 304 may generate a second, different tokenized QR code 307 that includes the user's account information 308, the determined sum total 310 and the provider's account information 309. In some cases, the QR code 307 may be generated by the mobile wallet application 302 running on the mobile device 301. The tokenized QR code may then be sent to the financial transaction processing system 315 and, after the transaction has been processed, the mobile device 301 may receive an electronic receipt 319 indicating that the financial transaction was processed. The electronic receipt may list each of the items that were paid for during the transaction.

Still further, in an embodiment described from the provider's perspective, the media provider may be able to directly sell media items using a QR code. The provider 311 may generate a tokenized QR code 312 that includes embedded (and encrypted) account information of the media provider for use in processing transactions with the media provider. The media provider 311 may receive a request from a user 306 indicating that the user intends to initiate a financial transaction to pay for various selected items provided by the media provider. The provider 311 then sends the generated tokenized QR code to the user 306. As such, the tokenized QR code may be received at a mobile wallet application running on a mobile digital device 301 of the user 306. After the transaction has been processed, the provider 311 may then receive an electronic receipt 319 of the transaction. As above, the receipt may provide an indication of which items were paid for by the user using the QR code and the mobile wallet application. As such, providers may sell and users may buy directly from media providers using QR codes.

In some embodiments, media producers may upload their media items directly to the entertainment platform's data store 229. Then, once a user has paid for the media item, the cloud-based entertainment platform 225 may transfer the media item to the user's phone 301. Alternatively, the media item may remain stored on the platform's data store 229, and may be streamed to the user on demand. In other cases, the media producer 311 may transfer purchased media items directly to consumers (or stream them on demand directly to the consumer), as desired by the consumer. Media producers may also use the entertainment platform to promote and sell entertainment content to other consumers based on contact lists stored in the mobile phone, or those contact lists that are accessible through social networking sites. In this manner, the cloud-based entertainment platform 225 directly connects artists or other media producers to consumers and allows those consumers to purchase media items directly from the media producers.

In one example, the cloud-based entertainment platform includes the following: one or more processors, system memory, a data store that stores entertainment content, including at least one of the following media items: music, movie and video game content, an authentication module that, upon receiving credentials from a user, authenticates that user to the cloud-based entertainment platform, a payment module that receives payment data from the authenticated user and processes a payment transaction for one or more of the stored media items, the payment data comprising a tokenized QR code that includes an indication of the media items being purchased and embedded account information for both the provider of the selected media items and the user, and a data providing module that, upon determining that the authenticated user has paid for a media item, transmits the purchased media item to the user. The user's phone may be a smart phone, a feature phone, a tablet or other type of mobile computing system.

The cloud-based entertainment platform may process payments by performing the following steps: determining from the tokenized QR code the amount of money that is to be transferred from the user to the media item provider as part of the financial transaction, determining which of the user's stored value accounts is to be used to pay for the one or more items provided by the provider, transferring the determined amount of money from the determined stored value account to the media item provider's account and sending an electronic receipt of the financial transaction to the user and the media item provider, as explained above with regard to FIG. 3. Additionally or alternatively, payment processing may include determining that one or more discounts or loyalty points are to be applied to the financial transaction to reduce the amount of the financial transaction by a specified amount and applying the discounts or loyalty points to the transaction to reduce the amount of the transaction by the specified amount.

Accessing media content provided by the cloud-based entertainment platform may include one or more of the followings steps: receiving an indication of one or more media items provided by the cloud-based entertainment platform, the media items including one or more of the following: music, movies and games, selecting one or more media items that are to be purchased using a tokenized quick response (QR) code, sending one or more user credentials to the cloud-based entertainment platform to authenticate the user, receiving an indication that the user has been authenticated to the cloud-based entertainment platform, generating a tokenized QR code including an indication of the media items being purchased and embedded account information for both the provider of the selected media items and the user, sending the generated tokenized QR code to the cloud-based entertainment platform, and receiving an electronic receipt of the financial transaction to the user and the provider.

In some cases, the cloud-based entertainment platform may be linked with other media platforms, social networks or ranking systems. For instance, the entertainment platform 225 may be configured to notify music ranking services when certain music tracks are purchased (or when any music track is purchased). Then, music ranking services, such as SoundScan, can receive live feedback from the entertainment platform 225, indicating which songs are currently being purchased and which songs have been purchased in the past. In this manner, the music ranking service (or other services such as movie, video game or app ranking services) can tracks which music (or other media) items are purchased using the cloud-based entertainment platform.

When media items are purchased using the entertainment platform 225, each purchased media item may retain a tokenized QR code that corresponds to that media item. For instance, if user 205 purchases a music track or movie 320, a tokenized QR code may be digitally attached to or embedded within the purchased music track or movie. The media item may be transferred to the user 306 from the entertainment platform 225 or from the provider of media items or services 311. This QR code may be designed to remain with the media item, even if it is subsequently transferred. The QR code may also be encoded to include an expiration date, maximum number of uses and free trial or other promotional offer for a related media item. In some cases, it may be possible for the user 306 to transfer the purchased media item to another user, such as a friend. The subsequent user may receive the transferred media item on their phone, and may access it in the normal fashion. The media item's corresponding tokenized QR code is transferred with full rights along with the media item. As such, the original user no longer retains the media item or the corresponding tokenized QR code.

Still further, at least in some embodiments, a referral system may be put into place by the entertainment platform 225, such that if the user refers or recommends a media item to a friend or other user, and that other user purchases the recommended media item, the first user will receive a commission based on the other user's purchase. The commission may be a flat amount for each referral, or may vary, perhaps in accordance with the price of the media item. In this manner, the entertainment platform 225 facilitates media item transfers between users, and further allows users to receive commissions when other users purchase items referred to them. These commissions may be paid to the user's mobile wallet or to some other established value store. In this scenario, user 306 transfers the purchased media item 320 to another user without full rights.

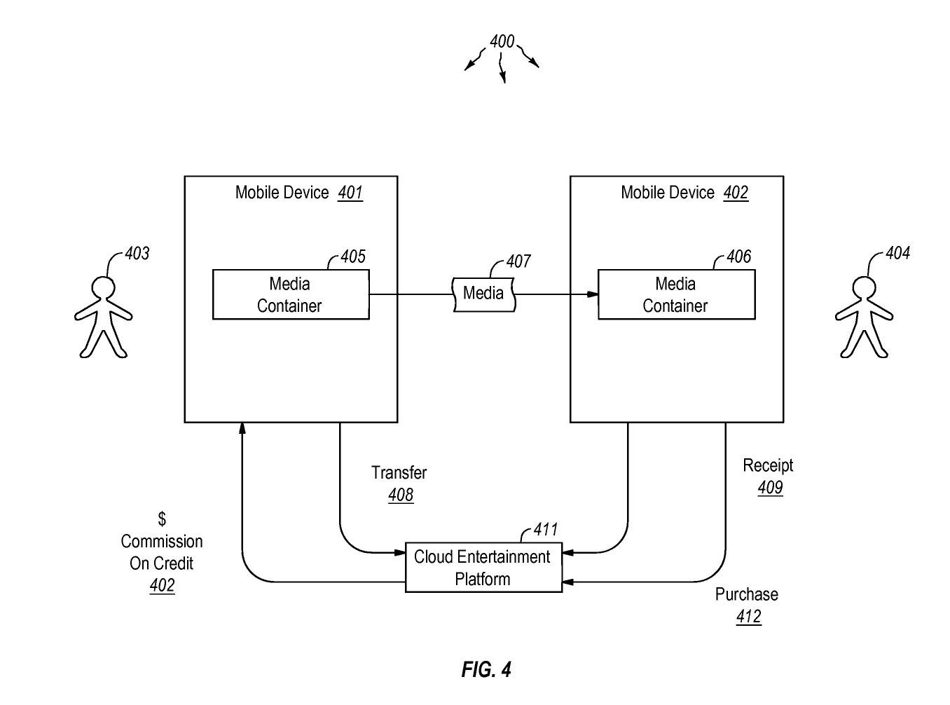

FIG. 4 illustrates an embodiment in which a purchased media item may be transferred from a first user 403 to a second user 404. First user 403 initiates a media transfer from media container 405. At the time of the transfer, a transfer log 408 is sent from mobile device 401 to the cloud entertainment platform 411. The transfer log includes the date and time of the media transfer, as well as account information for the sender and recipient (i.e. users 403 and 404). The media item 407 may be encoded and may or may not include full access rights to own the media. For example, media item 407 may be encoded with a “free trial” offer to use the media for a specified number of times or for a certain amount of time. Media item 407 may also be encoded with account information associated with first user 403.

The mobile device 402 may receive the media item 407 from mobile device 401. Upon receipt, mobile device 402 sends a receipt log 409 to the cloud entertainment platform 411. The receipt log includes the date and time of the media transfer, as well as account information for the sender and the recipient. The media item 407 may be stored in media container 406 of mobile device 402. If user 404 decides to purchase media item 407, a purchase acknowledgement 412 is sent to the cloud entertainment platform 411. The cloud entertainment platform 411 confirms the purchase of media item 407 with user 403 based on the transfer 408 and, at least in some cases, may pay a commission to user 403. In this manner, users may be incentivized to share media items with others (who can access those media items on a limited basis) and receive a commission if the other users ultimately purchase the media item.

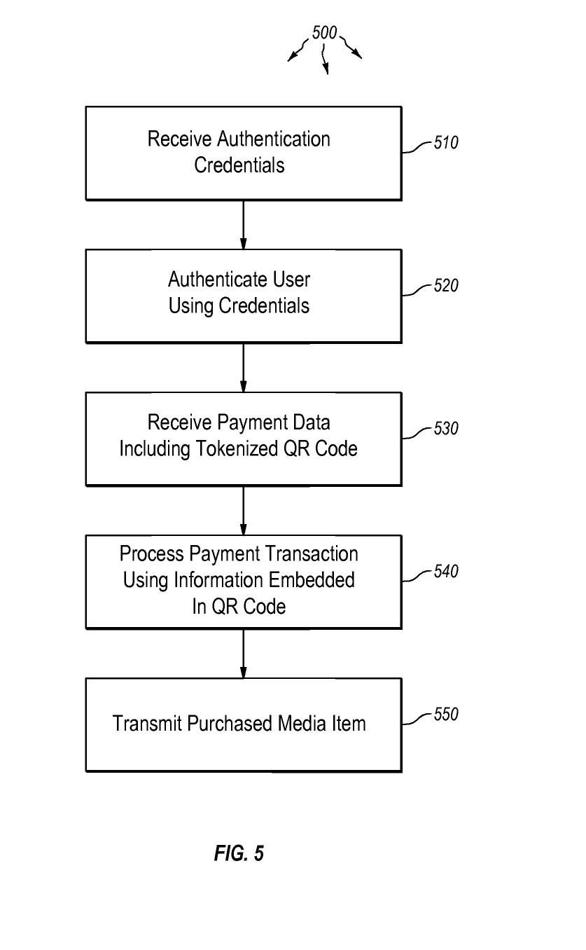

FIG. 5 illustrates a method 500 for purchasing content provided by a cloud-based entertainment platform. The method 500 will now be described with frequent reference to the components and data of environment 200 of FIG. 2.

Method 500 includes receiving one or more authentication credentials from a user (510). For example, the cloud entertainment platform 225 may receive authentication credentials 232 from user 205. These authentication credentials may include user name, password, biometric information, personal identification number (PIN) or other information used to identify and/or authenticate the user. The authentication module 233 may authenticate the user 205 using the received authentication credentials (520). The cloud entertainment platform 225 may further receive payment data from the authenticated user 205, where the payment data comprising a tokenized QR code 221 that includes an indication of the media items 228 being purchased and embedded account information for both the provider of the selected media items and the user (530). The provider of the media items may be the producer of the media items, or may be a re-seller or storefront for media items produced by other individuals or entities.

The payment processing system of the cloud entertainment portal 225 may process a payment transaction based on the indication of media items 228 being purchased and the embedded account information in the tokenized QR code 221 (540). Then, upon determining that the authenticated user 205 has paid for a media item, the media item providing module 231 transmits the purchased media item 228 to the user 205 (550). Each module of the cloud entertainment platform may be stored on a different physical or virtual computing system, and each module may provide its functionality independent of the other modules. Accordingly, the media item providing module 231 may transmit the purchased media item 228 to the user (i.e. to the user's device) in a variety of different manners including streaming the media item (e.g. a song, movie or game) or may transmit the media file(s) downloadable objects that are to be received and stored. The media item providing module 231 may alternatively just host the media item and provide it for download via a website or via an application on-demand. This functionality may be provided independent of the payment processing system 226 or the authentication module 233.

In some embodiments, the cloud entertainment platform 225 includes a data store that stores the entertainment content including the media items 228. In some cases, the data store may be configured to store other portions of content including application content or business content that is separate from the media items 228. At least in some cases, this other content may be provided to users upon the user being authorized to access the content and after paying for (or renting) the content. It will be understood that the media item providing module 231 may provide the media items or other content in various formats, encodings, file-types or other variants, and may provide the content using one or more different transmission protocols including wired and wireless transmission protocols. The media items or other content may be sent to users' devices including stationary or mobile devices (e.g. mobile phones, tablets, laptops, wearable devices, etc.). The user's mobile device may be a feature phone with only a limited set of features (e.g. only phone and text capabilities), or a smart phone with a wide range of features and capabilities.

The payment processing system 226 may access the QR code 221 received from the mobile computing system 201 to determine the amount of money that is to be transferred from the user 205 to the media item provider as part of the financial transaction. The payment processing system 226 may determine which stored value accounts associated with the user are to be used to pay for the media items indicated in the tokenized QR code. These stored value accounts may be debit, credit or similar accounts or other stores of value. The payment processing system 226 of the cloud entertainment platform 225 may then transfer the determined amount of money from the specified stored value accounts to an account associated with the media item provider, and may further send an electronic receipt of the financial transaction to the user and the media item provider.

In another embodiment, the payment processing system 226 of the cloud entertainment platform 225 may determine that various discounts or loyalty points are to be applied to a given financial transaction to reduce the amount of the financial transaction by a specified amount. Once this determination has been made, the payment processing module 226 may apply the discounts or loyalty points to the transaction to reduce the amount of the transaction by the specified amount. In some cases, making such a determination may also include accessing a purchasing history associated with the user to determine whether the user qualifies for discounts or loyalty points based on the user's purchasing history. The user may then receive discounts or loyalty points commensurate with the number and/or type of items listed as purchased in their purchasing history. In still other embodiments, the media item provider (e.g. the producer or re-seller) may specify which payment network is to be used to route the transactions through. For instance, the media item provider may indicate that a debit account is to be used which is accessible through debit network 230A, or that a prepaid debit card is to be used which is accessible through debit network 230B, or that a credit account is to be used which is accessible through a credit network 230C. In this manner, a media item provider may have control over which payment network is used to process the transactions.

As further described herein below, a computing system may be provided which allows content to be purchased using a QR code. In some cases, this computing system may be the cloud entertainment platform 225. The cloud entertainment platform 225 may include a data store 229 that stores entertainment content including media items 228. The cloud entertainment platform 225 may also include an authentication module 233 which, upon receiving credentials 232 from a user 205, authenticates the user to the cloud-based entertainment platform 225. The cloud entertainment platform 225 may further include a payment module that receives payment data from the authenticated user 205 and processes a payment transaction that includes the stored media items 228, where the payment data contains a tokenized QR code 221 that includes an indication of the media items being purchased and embedded account information for both the provider of the selected media items and the user 205. The cloud entertainment platform 225 may further include a data providing module 231 which, upon determining that the authenticated user has paid for a media item, transmits the purchased media item 228 to the user 205.

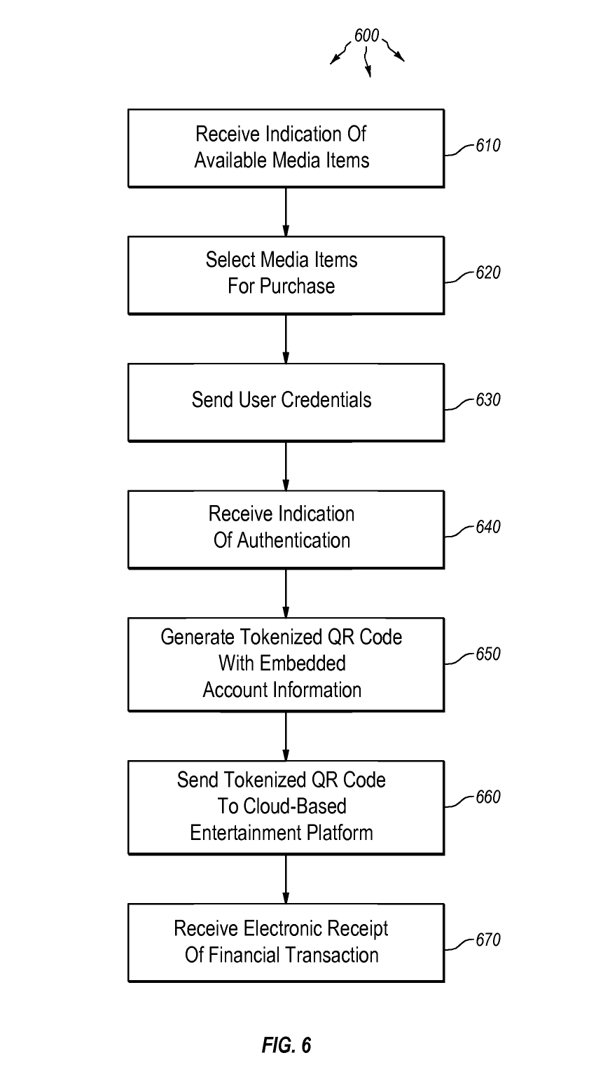

FIG. 6 illustrates a method 600 for accessing media content provided by a cloud-based entertainment platform. The method 600 will now be described with frequent reference to the components and data of environment 300 of FIG. 3.

Method 600 includes receiving an indication of one or more media items provided by the cloud-based entertainment platform (610). This indication may be provided via a web page that lists the media items available for purchase (or rent), or via an application such as a smart phone application, or via some other means (such as a list of media items in a SMS text message). Method 600 further includes receiving a selection of one or more of the provided media items that are to be purchased using a tokenized quick response (QR) code (620). For instance, mobile device 301 may receive an indication from user 306 selecting one or more of the media items 320 that the user intends to purchase. The user may send user credentials to the cloud-based entertainment platform to authenticate the user (630) and receive an indication that the user has been authenticated to the cloud-based entertainment platform (640). The user's authentication credentials may be encrypted using at least one form of encryption prior to transfer.

Method 600 further includes generating a tokenized QR code including an indication of the media items being purchased and further includes embedded account information for both the provider of the selected media items and the user (650). The QR code generating module 304 may generate tokenized QR code 307 which includes user account information 308, media item provider account information 309 and transaction information 310 outlining the details of the transaction. This QR code may then be sent to the cloud-based entertainment platform for processing of the payment transaction using the embedded account information (660). As shown in FIG. 3, the tokenized QR code 307 may be sent to the financial transaction processing system 315, which may be part of the cloud entertainment platform 225 of FIG. 2, and may be the same as the payment processing system 226 of FIG. 2. The mobile device 301 may then receive an electronic receipt 319 of the financial transaction indicating the status of the transaction (670). If the transaction was successful, it would show that the items were paid for and which payment method was used to pay for the items.

In some embodiments, the mobile device 301 of FIG. 3 may be a cellular telephone, a smartphone or a feature phone. The feature phone or smart phone may include a physical or virtual button that initiates QR code payments. The QR code may thus be generated by a mobile phone such as a smart phone or feature phone, and may be generated by a mobile wallet application running on that phone. The feature phone or smart phone may also include a physical or virtual button that allows the user to select a payment network. Still further, the feature phone or smart phone may include a physical or virtual button that opens the user's mobile wallet application.

Media items provided by different media item producers may be watermarked with a digital watermark that corresponds to the media item provider. This watermark may be applied automatically at the time of download or streaming by the user. Indeed, any of the purchasable media items may be stored by the cloud-based entertainment platform (e.g. in data store 229) and may be streamed to the mobile computing system on-demand. The digital watermark may be applied to media items stored in the data store, or may be applied as the item is transferred from the cloud entertainment platform 225 to the user. In some cases, once a media item purchase transaction has completed, a music/movie/video game ranking service may be notified of the purchase transaction. The music (or other media) ranking service may track which media items are being purchased using the cloud-based entertainment platform and may provide reports based on this information.

In some cases, as mentioned above in regard to FIG. 4, the purchased media item may retain a tokenized QR code that corresponds to the media item and the user that purchased the media item. In this manner, if the user shares the item with another user, the shared item will retain the tokenized QR code of the sharer. Then, if the other user purchases the item, the sharer may receive a commission. Alternatively, if the user/sharer wants to permanently transfer the media item to another user, the media item's corresponding tokenized QR code is transferred with the media item, so that the original user no longer retains the media item or the corresponding tokenized QR code.

Accordingly, methods, systems and computer program products are provided which purchase content provided by a cloud-based entertainment platform. Moreover, methods, systems and computer program products are provided which access media content provided by a cloud-based entertainment platform.

It should be noted that the concepts and features described herein may be embodied in other specific forms without departing from their spirit or descriptive characteristics. The described embodiments are to be considered in all respects only as illustrative and not restrictive. The scope of the disclosure is, therefore, indicated by the appended claims rather than by the foregoing description. All changes which come within the meaning and range of equivalency of the claims are to be embraced within their scope.

We claim:

1. A cloud-based entertainment platform, comprising:
one or more processors;
system memory;
a data store that stores entertainment content including at least one media item;
an authentication module which, upon receiving credentials from a user, authenticates the user to the cloud-based entertainment platform;
a payment module that receives payment data from the authenticated user and processes a payment transaction that includes one or more of the stored media items, the payment data comprising a tokenized QR code that includes an indication of the media items being purchased and embedded account information for both the provider of the selected media items and the user; and
a data providing module which, upon determining that the authenticated user has paid for a media item, transmits the purchased media item to the user.

2. The cloud-based entertainment platform of claim 1, wherein the purchased media items is sent to a mobile device associated with the user.

3. The cloud-based entertainment platform of claim 1, wherein processing the payment transaction comprises:
determining, from the tokenized QR code, the amount of money that is to be transferred from the user to the media item provider as part of the financial transaction;
determining which one or more stored value accounts associated with the user are to be used to pay for the media items indicated in the tokenized QR code;
transferring the determined amount of money from the determined one or more stored value accounts to an account associated with the media item provider; and
sending an electronic receipt of the financial transaction to the user and the media item provider.

4. The cloud-based entertainment platform of claim 1, wherein processing the payment transaction comprises:
determining that one or more discounts or loyalty points are to be applied to the financial transaction to reduce the amount of the financial transaction by a specified amount; and
applying the discounts or loyalty points to the transaction to reduce the amount of the transaction by the specified amount.

5. The cloud-based entertainment platform of claim 4, wherein determining that one or more discounts or loyalty points are to be applied to the financial transaction to reduce the amount of the financial transaction comprises accessing a purchasing history associated with the user to determine whether the user qualifies for discounts or loyalty points based on the user's purchasing history.

6. The cloud-based entertainment platform of claim 1, wherein the media item provider specifies which payment network is to be used to route the transactions through.

7. The cloud-based entertainment platform of claim 6, wherein the stored value account comprises at least one of a debit account accessible through a debit network, a prepaid debit card accessible through a debit network, or a credit account accessible through a credit network.

8. A mobile computer system comprising the following:
one or more processors;
system memory;
one or more computer-readable storage media having stored thereon computer-executable instructions that, when executed by the one or more processors, causes the computing system to perform a method for accessing media content provided by a cloud-based entertainment platform, the method comprising the following:
receiving an indication of one or more media items provided by the cloud-based entertainment platform;
receiving a selection of one or more of the provided media items that are to be purchased using a tokenized quick response (QR) code;
sending one or more user credentials to the cloud-based entertainment platform to authenticate the user;
receiving an indication that the user has been authenticated to the cloud-based entertainment platform;
generating a tokenized QR code including an indication of the media items being purchased and further includes embedded account information for both the provider of the selected media items and the user;
sending the generated tokenized QR code to the cloud-based entertainment platform for processing of the payment transaction using the embedded account information; and
receiving an electronic receipt of the financial transaction indicating the status of the transaction.

9. The mobile computing system of claim 8, wherein the mobile computer system comprises at least one of a cellular telephone, a smartphone or a feature phone.

10. The mobile computing system of claim 9, wherein the tokenized QR code is generated by a mobile wallet application running on a cellular telephone.

11. The mobile computing system of claim 9, wherein the feature phone comprises a button that initiates QR code payments.

12. The mobile computing system of claim 9, wherein the feature phone comprises a button that allows the user to select a payment network.

13. The mobile computing system of claim 9, wherein the feature phone comprises a button that opens the user's mobile wallet application.

14. The mobile computing system of claim 8, wherein the user's authentication credentials are encrypted using at least one form of encryption.

15. The mobile computing system of claim 8, wherein the media items provided by the media item provider are watermarked with a digital watermark that corresponds to the media item provider.

16. The mobile computing system of claim 8, wherein purchased media items are stored by the cloud-based entertainment platform and are streamed to the mobile computing system on-demand.

17. The mobile computing system of claim 8, wherein the user comprises an unbanked user.

18. The mobile computing system of claim 8, wherein upon determining that a media item purchase transaction has completed, at least one music ranking service is notified of the purchase transaction.

19. The mobile computing system of claim 18, wherein the music ranking service tracks which music items are purchased using the cloud-based entertainment platform.

20. The mobile computing system of claim 8, wherein the purchased media item retains a tokenized QR code that corresponds to the media item and the user that purchased the media item.

21. The mobile computing system of claim 20, wherein the user transfers the purchased media item to another user, the media item's corresponding tokenized QR code being transferred with the media item, such that the original user no longer retains the media item or the corresponding tokenized QR code.

22. The mobile computing system of claim 8, wherein the user refers a media item to a second user and, upon determining that the second user has purchased the media item, the user receives a commission based on the second user's purchase.

23. At a computing system including at least one processor, a computer-implemented method for purchasing content provided by a cloud-based entertainment platform, the method comprising:
receiving one or more authentication credentials from a user;
authenticating the user to the cloud-based entertainment platform using the received authentication credentials;
receiving payment data from the authenticated user, the payment data comprising a tokenized QR code that includes an indication of the media items being purchased and embedded account information for both the provider of the selected media items and the user;
processing a payment transaction based on the indication of media items being purchased and the embedded account information in the tokenized QR code; and
upon determining that the authenticated user has paid for a media item, transmitting the purchased media item to the user.

24. The method of claim 23, wherein the cloud-based entertainment platform stores the entertainment content including at least one media item.

25. The method of claim 24, wherein the purchased media item is streamed to the user from the entertainment content stored on the cloud-based entertainment platform.
